(19) United States
(12) Patent Application Publication
(10) Pub. No.: US 2009/0078128 A1
(43) Pub. Date: Mar. 26, 2009

(54) Extruder of Vegetal Oil

(76) Inventor: Paulo Roberto Galvao, Iracema do Oeste (BR)

Correspondence Address: LAW OFFICES OF ALBERT WAI-KIT CHAN, PLLC, WORLD PLAZA, SUITE 604, 141-07 20TH AVENUE, WHITESTONE, NY, 11357, US

(21) Appl. No.: 11/719,375

(22) PCT Filed: Nov. 14, 2005
(86) PCT No.: PCT/BR2005/000236

§ 371 Date: May 15, 2007

(30) Foreign Application Priority Data
Nov. 16, 2004 (BR) MU8402851-3

(51) Int. Cl. A23P 1/12

(52) U.S. Cl. 99/485

(57) ABSTRACT

Extruder of vegetal oil formed by a system for the Oil and Flour Production from primary products, that works in a different way from the existing squeezers and known in the actual market. This extraction system, with this system of the present patent simplifies and improves the processes that use the actual equipments, and also saves the energy consumption by incrementing the yield of the obtained production when compared with the existing equipments. The former result is due to this system that works simultaneously the different processes in only one machine, what nowadays is made in a series of machines in each one of the different processes. In the actual systems several different processes are used, one for the oil extraction and others more for the transformation of sub-products until reach the final product; using different equipments in each case after the oil extraction.

### TECHNICAL FIELD

The present Utility Model Patent refers to a system for the Oil and Flour Production from primary products, that works in a different way from the existing squeezers and known in the actual market. This extraction system also has the toasting of sub-products, improving the processes that use the actual equipments, because besides improving, it also saves the energy consumption by incrementing the yield of the obtained production when compared with the existing equipments. The former result is due to this system that works simultaneously in different processes in only one machine, what nowadays is made in a series of machines in each one of the different processes.

### BACKGROUND ART

In the actual systems several different processes are used, one for the oil extraction and others more for the transformation of sub-products until is reached the final product; using different equipments in each case after the oil extraction. To begin the first process, squeezers are used in the oil extraction and the series of processes from the sub-products that remain after the pressing of the raw material, then to use driers to take out the humidity and depending on the necessity, it follows with other different equipments that undertake the crushing, toasting and homogenization of the flour.

### DISCLOSURE OF THE INVENTION

The novelty of the system covered by the present patent invention consists of one machine that makes all required processes in a simultaneous way, squeezes the oil, crushes it and dries the sub-products, toasts in selective grade the flour and ends with the homogenization.

The system for the oil and flour production from raw materials comprises in one machine that makes simultaneously all the required processes in the processing of raw material, that contains oil, such as: seeds, meal, fruits, legumes, etc., what makes this machine a versatile and efficient one.

The former consists in using only one machine that is capable to execute these multiple processes in a simultaneous way, using only one engine as an energy source in its work, not requiring multiple equipments to perform the same work, as currently is the case.

For the execution of what is described above, the system is described in the foregoing description and a series of drawings of a machine, which have numbered indications for its identification, drawings that are just one of the possible embodiments for the system application; the drawings are not in any form to limit the scope of the present patent.

### BRIEF DESCRIPTION OF THE DRAWINGS

These brief descriptions of the drawings are intended to explain the system functioning of the present invention, drawings that are just one of the embodiments, not limiting the scope of the patent application.

FIG. 1 is a side view of the machine;

FIG. 2 corresponds to a front view of the machine;

FIG. 3 shows the helicoidal equipments, with an obstruction in the central part, being one of them for advancing and the other for retrocession;

FIG. 4 is a side cut of the machine with simple helicoidal equipment with a central obstruction;

FIG. 5 is a machine, similar to the former FIG. 4, with duplicate helicoidal equipment, one after another (if there is necessity it can be triple helicoidal equipments, one after another);

FIG. 6 shows a detail of the obstruction where it can be seen the restriction channels of the passage material, which are regulated with screws;

FIG. 7 is a detail of the enveloping showing the channels where are positioned the fillets that avoids the compacting of the material, preventing it to spin adhering to the helicoidals.

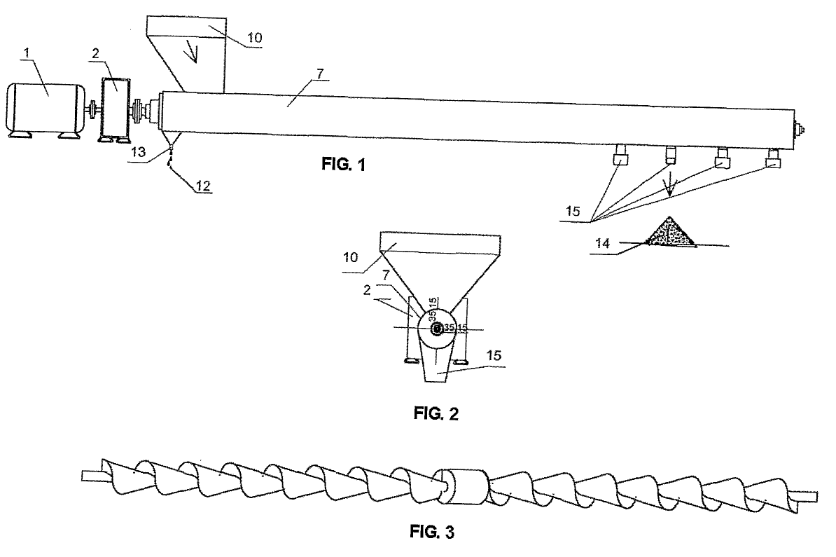

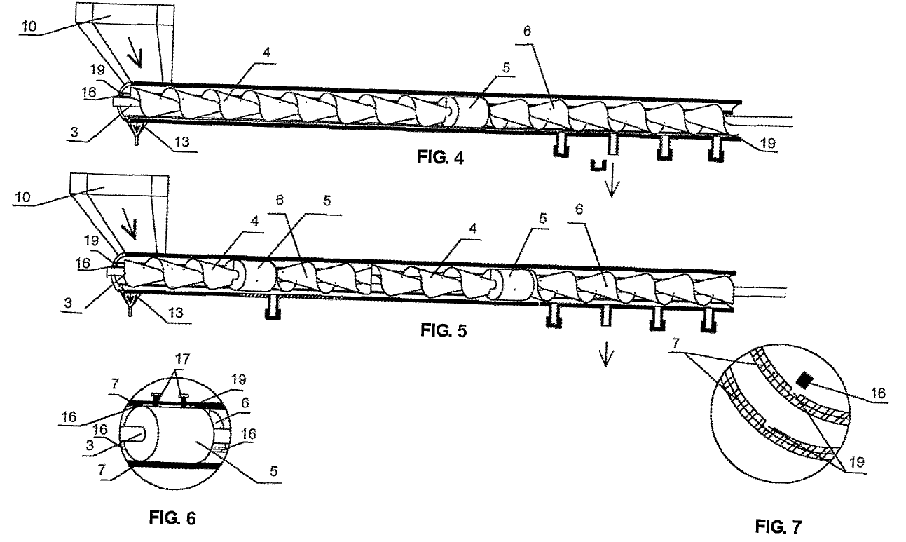

### GENERAL DESCRIPTION OF EMBODIMENTS

The description of the system for the Oil and Flour Production from primary products uses a machine, according to the sequence in that works the processes comprehended in the system, after the general description:

The machine to execute simultaneously the processes series is comprised of an engine (1), which is responsible, through a speed limiter (2), to rotate a part composed of four different pieces: an axle (3), the advance helicoidal (4), the obstruction cylinder (5) and the retrocession helicoidal (6). This part is installed inside the cylindrical cover (7) and is supported in two bearings (8) and (9) placed in the anterior and posterior covers of the cylindrical cover (7), that has next to the engine (1) is placed a funnel (10) to receive the feeding of the raw material. At the same place of the feeding funnel, but in the low part of the cylindrical cover (7) has a series of grooves (11) for the oil outlet (12) that is collected in the oil discharge funnel (13), of the opposite side also has a series of outlets (14) for the flour, located in the low part through little threaded tubes (15) that can be closed with its lid, thus selecting the required grade for toasting in the process.

### Description of Embodiments

There are certain special features in this present patent that makes it possible the system functioning and these features are:

The helicoidals, the advance helicoidal (4) as well as the retrocession helicoidal (6), have a special feature in its design, that consist that they have in the helix a different inclination format of the usual helicoidals, that has the helix in all its extension perpendicular to the axle, in exchange the special form of the helicoidals of the present patent are placed in the axle to form an obtuse angle in relation to its axle, feature that makes the transported product, besides being transported, it is pressed against the cylindrical cover (7) in order to be compressed. Another difference or special feature in relation to the usual helicoidals is that the cylindrical cover (7) has some fillets (16) placed in some grooves (18) made on the cylinder cover (7) in the extension of the cover, except in the part in which is placed the obstruction cylinder (5), these fillets are used to avoid that the material be compacted and keep spinning in the helicoidal. The grooves (11) that remain opened in the space where is placed the obstruction cylinder (5) are used to enable the passage of the material, controlling it by means of some screws (17). Other difference that this machine has is that the obstruction cylinder (5) is installed in the convergence of the helicoidals, so it can obstruct the passage of the material, increasing the pressure made on it.

### Description of the Processes

*Oil Extraction

The raw material is introduced in the machine through the feeding funnel (10), and when it enters in contact with the advance helicoidal (4) it begins its course inside the cylindrical cover (7), where it is pressed when it is advanced due to the special feature of its design, that besides to advance, it compress the material against the cylindrical cover (7), but there are fillets (16) embedded in the grooves (19) of the cylindrical cover (7) with the objective to avoid that the material be compacted and keep rotating in the helicoidal. This squeezing action of the material provokes the heating of the material thus facilitating the extrusion of the oil (12), that flows in the contrary direction of the advance, to go out by the little grooves (18) leaving out through the funnel (13). The oil (12) flows in the contrary direction to the advance because it recognizes where there is lesser pressure.

*Pulverization of Material

Due to the high pressure that the material is submitted, the material is heated, extrudes the oil and stays dried because the humidity is taken out in a steam form, giving margin to its destruction, being in the form of flour. This process is regulated through the action of the obstruction cylinder (5) that forces the passage of the material by the grooves (16) where the flow is controlled with the screws (17).

*Homogenized and Toasted of the Flour

After passing the obstruction cylinder (5) the already heated flour suffers a compression action even bigger by effect of the retrocession helicoidal (6) that is opposed to the advance of it originating the increase of the temperature in the flour, that is toasted and is even more homogenized, and the toasting grade is controlled by letting it to end the toasting process, letting it out by the little tubes (15), being different in each case.

Although particular embodiments of the invention have been shown and described, it will be understood that it is not intended to limit the invention to the embodiments disclosed.

1. EXTRUDER OF VEGETAL OIL characterized by the fact that: uses a special feature to generate the pressure to the oil extraction, that consists of helicoidals that have in the helix a different inclination format of the usual helicoidals, that have a helix in all of its extension perpendicular to the axle, in exchange the special form of the helicoidals of the present patent are placed in the axle to form an obtuse angle in relation to its axle, feature that makes the transported product, besides being transported, it is pressed against the cylindrical cover in order to be compressed.

2. EXTRUDER OF VEGETAL OIL, according to the claim 1, characterized by the fact that: an obstruction cylinder has been placed in the passage of the material, placed between the two helicoidals to provoke an increasing in the pressure, besides to facilitate the control over the toasting.

3. EXTRUDER OF VEGETAL OIL, according to the claim 1, characterized by the fact that: there are some fillets placed in the interior of the involving body of the helicoidals, to avoid that the material be compacted and keep rotating in the helicoidal.

4-5. (canceled)

6. EXTRUDER OF VEGETAL OIL, according to the claim 2, characterized by the fact that: there are some fillets placed in the interior of the involving body of the helicoidals, to avoid that the material be compacted and keep rotating in the helicoidal.

7. EXTRUDER OF VEGETAL OIL, according to the claim 1, characterized by the fact that: there are some grooves where with some screws that can be regulated in order to control the passage of the material calibrating the oil extruder machine.

8. EXTRUDER OF VEGETAL OIL, according to the claim 2, characterized by the fact that: there are some grooves where with some screws that can be regulated in order to control the passage of the material calibrating the oil extruder machine.

9. EXTRUDER OF VEGETAL OIL, according to the claim 3, characterized by the fact that: there are some grooves where with some screws that can be regulated in order to control the passage of the material calibrating the oil extruder machine.

10. EXTRUDER OF VEGETAL OIL, according to the claim 6, characterized by the fact that: there are some grooves where with some screws that can be regulated in order to control the passage of the material calibrating the oil extruder machine.

11. EXTRUDER OF VEGETAL OIL, according to the claim 1, characterized by the fact that: there is a series of discharges with funnel to take out the toasted flour according to the grade of toasted.

12. EXTRUDER OF VEGETAL OIL, according to the claim 2, characterized by the fact that: there is a series of discharges with funnel to take out the toasted flour according to the grade of toasted.

13. EXTRUDER OF VEGETAL OIL, according to the claim 3, characterized by the fact that: there is a series of discharges with funnel to take out the toasted flour according to the grade of toasted.

14. EXTRUDER OF VEGETAL OIL, according to the claim 6, characterized by the fact that: there is a series of discharges with funnel to take out the toasted flour according to the grade of toasted.

15. EXTRUDER OF VEGETAL OIL, according to the claim 7, characterized by the fact that: there is a series of discharges with funnel to take out the toasted flour according to the grade of toasted.

16. EXTRUDER OF VEGETAL OIL, according to the claim 8, characterized by the fact that: there is a series of discharges with funnel to take out the toasted flour according to the grade of toasted.

17. EXTRUDER OF VEGETAL OIL, according to the claim 9, characterized by the fact that: there is a series of discharges with funnel to take out the toasted flour according to the grade of toasted.

18. EXTRUDER OF VEGETAL OIL, according to the claim 10, characterized by the fact that: there is a series of discharges with funnel to take out the toasted flour according to the grade of toasted.
